(19) United States
(12) Patent Application Publication
(10) Pub. No.: US 2026/0045148 A1
(43) Pub. Date: Feb. 12, 2026

(54) GAMING SYSTEM AND GAMING MACHINE WITH BASE GAME WHEEL BONUS ACCUMULATION

(71) Applicant: Aristocrat Technologies Australia PTY Limited, North Ryde (AU)

(72) Inventors: Joshua Matos, Cordeaux Heights (AU); Antoon Visser, Coogee (AU); Karen Kendall, Toongabbie (AU); Zijun Chen, Baulkham Hills (AU)

(21) Appl. No.: 18/957,244

(22) Filed: Nov. 22, 2024

(30) Foreign Application Priority Data
Aug. 9, 2024 (AU) 2024205657
Aug. 9, 2024 (AU) 2024223973

(51) Int. Cl. G07F 17/32; G07F 17/34

(52) U.S. Cl. CPC G07F 17/3267; G07F 17/34

(57) ABSTRACT

A gaming machine, gaming system and method of operating a gaming machine, which are adapted to implement a combination spinning reel and wheel game. During a base game, a plurality of different trigger symbols are provided on the reels, where one trigger symbol is associated with the wheel, and each of the other different trigger symbols is associated with a different feature having specified game play characteristics. Feature game trigger symbols can be accumulated during base game play from reel and from wheel spins and/or triggered by occurrence of a wheel spin trigger condition being fulfilled during base game play.

### CROSS-REFERENCE TO RELATED APPLICATIONS

The present application claims priority to Australian Patent Application No. 2024205657, filed Aug. 9, 2024, and Australian Patent Application No. 2024223973, filed Aug. 9, 2024.

### FIELD

The present application relates to a gaming machine and method of operating a gaming machine and gaming system to provide a base game wheel bonus accumulation for high volatility operation.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. Upon initiation of play, the RNG randomly determines a game outcome, and symbols are then selected which correspond to that outcome. Notably, some games may include an element of skill on the part of the player and are therefore not entirely random.

A problem for game designers is development of games which can provide variety in volatility (size and frequency of payouts). There is a need for new gaming machines to provide improved options for game designers to manipulate probabilities and volatility.

### SUMMARY

Embodiments provide a gaming machine, gaming system and method of operating a gaming machine which are adapted to implement a combination spinning reel and wheel game. During a base game, a plurality of different trigger symbols are provided on the reels, where one trigger symbol is associated with the wheel, and each of the other different trigger symbols is associated with a different feature having specified game play characteristics. The different trigger symbols can also trigger one or more composite feature games, where the trigger symbols occur in combination. Feature game triggers can also be accumulated during base game play from wheel spins, triggered by occurrence of a wheel spin trigger condition being fulfilled during base game play. The different trigger symbols can be scatter symbols and are accumulable from occurrence of the scatter symbols on the reels during reel spins or from wheel spins.

Use of the different triggers enables a player to readily understand the game play and accumulation of features. By enabling combinations of features game designers are able to manipulate volatility based on the compound probabilities associated with the various specified game play characteristics for different features. Whether or not a trigger symbol occurrence triggers award of an associated feature in some embodiments is based on a weighting table, the weighting table may be varied by designers to manipulate volatility or vary game operation without otherwise affecting operation of the gaming machine.

Some embodiments enable composite feature games made up of individual game play characteristics of the feature games directly associated with the trigger symbols. These have the chance of triggering when a plurality of different trigger symbols land on the reel. When one or more trigger symbols land on the reels, the processor of the gaming device determines the identity of the trigger symbol(s) and assesses trigger conditions where each individual feature corresponding to the trigger symbol(s) has a chance of triggering an associated feature as well as any composite feature(s) that correspond to the selected combination of trigger symbols. In one example there are three different feature trigger symbols associated with feature game play characteristics, and another trigger symbol associated with a wheel. In some embodiments an extreme composite game may be triggered which combines all feature game play characteristics in one composite game.

In one example, there are four trigger symbols and seven possible feature games including three composite feature games. It will be appreciated that this embodiment enables a greater variety of feature games to be provided while enabling the player to comprehend the underlying trigger mechanism.

A first aspect of the present disclosure provides a gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with at least one wheel sector associated each of the different game play features, and at least one wheel sector associated with each one of a plurality of awards, and indicia for display in each respective wheel sector represent the sector association, and (v) one or more weight tables, and wherein the game controller is operable to assign prize values based on random outcomes as required during play of the game, the game controller executing the game program code stored in the memory and responsive to initiation of the play of the game with the game play mechanism to: configure the reels by replacing each instance of the dynamic scatter symbols of the reels with one of two or more of the feature associated scatter symbols; select a plurality of symbols from the configured reels using the random number generator, and control the display to display the selected symbols in a plurality of columns of display positions to generate a reel spin outcome; make an award of credits to the win meter or the credit meter based on any prize values assigned to combinations of symbols in the reel spin outcome; review the reel spin outcome to determine any occurrence of a feature associated scatter symbol, wherein: for each game play feature associated scatter symbol occurrence, assess a trigger condition for the game play feature based on a weight table and a random number generator output, and where the trigger condition is met provide an indication that the game feature is to be awarded; for an occurrence of the wheel feature associated scatter symbol trigger a wheel spin to select a wheel sector based on an output of the random number generator, wherein selecting a sector associated with a prize award causes an award of credits to the win meter or the credit meter based on the prize; selecting a sector associated with one of the features causes assessment of a trigger condition for the game play feature based on a weight table and a random number generator output, and where the trigger condition is met provide an indication that the game feature is to be awarded and modifying the selected sector to become associated with a start feature trigger; and selecting a sector associated with a start feature trigger will cause start of a feature game wherein the game features to be awarded triggered from the spinning reel and wheel are provided in the feature game, and wherein wheel spins are repeated until selection of the start trigger sector.

A second aspect of the present disclosure provides a method of operating a gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with one wheel sector associated with a start feature trigger, and each other sector associated with one of the different game play features or one of a plurality of awards, and indicia for display in each respective wheel sector represent the sector association, and (v) one or more weight tables, and wherein the game controller is operable to assign prize values based on random outcomes as required during play of the game, the game controller executing the game program code stored in the memory and responsive to initiation of the play of the game with the game play mechanism, the method comprising the steps of: configuring the reels by replacing each instance of the dynamic scatter symbols of the reels with one of two or more of the feature associated scatter symbols; selecting a plurality of symbols from the configured reels using the random number generator, and control the display to display the selected symbols in a plurality of columns of display positions to generate a reel spin outcome; making an award of credits to the win meter or the credit meter based on any prize values assigned to combinations of symbols in the reel spin outcome; reviewing the reel spin outcome to determine any occurrence of a feature associated scatter symbol, wherein: for each game play feature associated scatter symbol occurrence, assess a trigger condition for the game play feature based on a weight table and a random number generator output, and where the trigger condition is met provide an indication that the game feature is to be awarded; for an occurrence of the wheel feature associated scatter symbol trigger a wheel spin to select a wheel sector based on an output of the random number generator, wherein selecting a sector associated with a prize award causes an award of credits to the win meter or the credit meter based on the prize; selecting a sector associated with one of the features causes assessment of a trigger condition for the game play feature based on a weight table and a random number generator output, and where the trigger condition is met provide an indication that the game feature is to be awarded; and selecting a sector associated with a start feature trigger will cause start of a feature game wherein the game features to be awarded triggered from the spinning reel and wheel are provided in the feature game.

A third aspect of the present disclosure provides a gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including a plurality of types of coin scatter symbols each type of coin scatter symbol being indicative of increasing values, and (v) for each reel a coin counter and an associated coin accumulation indicator having a plurality of states, and wherein the game controller is operable to assign prize values based on random outcomes as required during play of the game, the game controller executing the game program code stored in the memory and responsive to initiation of the play of the game with the game play mechanism to: configure the reels by replacing each instance of the dynamic scatter symbols of the reels with a feature associated scatter symbol selected from the set; select a plurality of symbols from the reels using the random number generator, and control the display to display the selected symbols in a plurality of columns of display positions to generate a reel spin outcome; make an award of credits to the win meter or the credit meter based on any prize values assigned to combinations of symbols in the reel spin outcome; review the reel spin outcome to determine any occurrence of a feature associated scatter symbol, wherein: for each occurrence of a coin scatter symbol on a reel: award any credit prize associated with the coin scatter symbol by award of credits to a win meter; increment the coin counter associated with the reel; assess a current reel state in relation to the incremented coin counter to determine whether a trigger condition for reel state transition is met for the reel; and update display of the coin accumulation indicator to visually indicate the incremented coin count and any determined new reel state.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is an example of a base game display showing an example of a reel window, feature accumulation indicators, and bonus wheel, the reel window showing feature associated scatter symbols.

FIG. 6 is a flow chart of an example of a base game reel spin process.

FIG. 7 is a flow chart of an example of a base game wheel spin process.

FIG. 8 is an example of a base game display of FIG. 5 showing an example of scatter symbols associated with the base game bonus wheel.

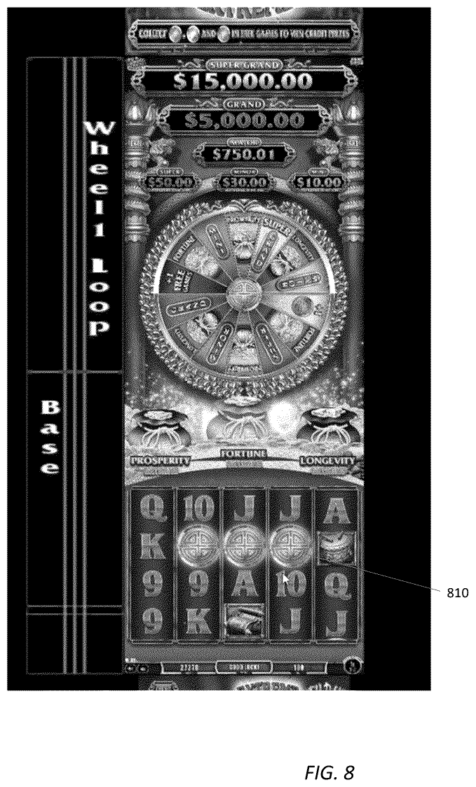

FIG. 9 is an example of a base game display of FIG. 5 showing an example of an announcement screen indicating the base game bonus wheel spin is triggered.

FIG. 10 is an example of a base game display of FIG. 5 showing an example of scatter symbols associated all three game features appearing in the game outcome, with the feature accumulation indicators (bags) in a non-triggered state.

FIG. 11 is an example of a base game display of FIG. 5 showing an example of scatter symbols associated all three game features appearing in the game outcome, with the feature accumulation indicators (bags) all in a triggered state.

FIG. 12 is an example of a base game display of FIG. 5 showing an example of an extreme state feature game triggered announcement, with the feature accumulation indicators (bags) all in a triggered state.

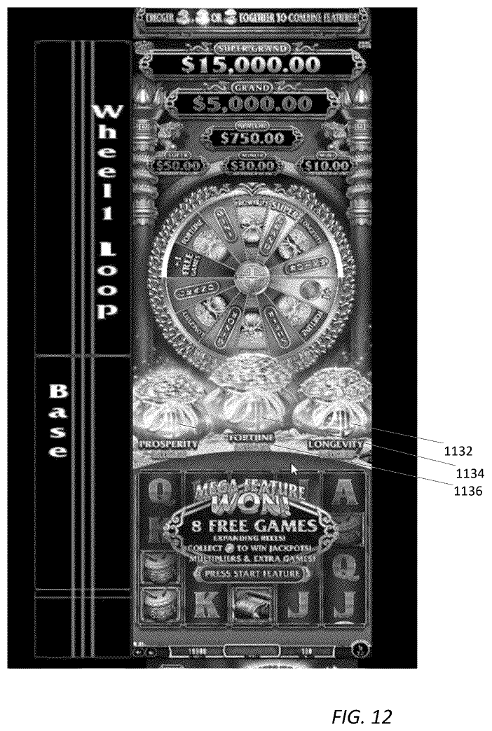

FIG. 13 is a flow chart of an example of a feature game reel spin process.

FIG. 14 is an example of a feature game display showing an example of an expandable reel window, and bonus wheel, the reel window showing a scatter symbols associated with a reel expansion and upgrade game features.

FIG. 15 is an example of the feature game display of FIG. 14 showing an example of an awarded reel expansion scatter symbols and expanded reel window, before award based on the upgrade scatter symbol.

FIG. 16 is an example of the feature game display of FIG. 15 showing reveal of an award based on the upgrade scatter symbol.

FIG. 17 is an example of the feature game display of FIG. 15 showing after an award based on the upgrade scatter symbol, showing reel 5 at an upgraded level.

FIG. 18 is an example of the feature game display of FIG. 15 showing a stack symbol which can act as a WILD symbol and an upgrade scatter symbol.

FIG. 19 is an example of the feature game display of FIG. 18 showing a reveal of an award for the upgrade scatter symbol.

FIG. 20 is an example of the feature game display of FIG. 19 showing the stack symbol as a WILD symbol and after the upgrade award to increment the level of reel 1.

FIG. 21 is an example of the feature game display of FIG. 19 showing a further reel window expansion and reveal of a credit value for a coin scatter symbol.

FIG. 22 is an example of the feature game display of FIG. 20 showing a further reel window expansion and reveal of a credit value for a coin scatter symbol.

FIG. 23 is an example of the feature game display of FIG. 20 showing a reel spin scatter symbol and coin scatter symbols.

FIG. 24 is an example of the feature game display of FIG. 23 showing reveal of the coin scatter symbols before spinning the reel.

FIG. 25 is an example of the feature game display of FIG. 23 after execution of a reel spin landing on the boost segment, showing increase in the value ranges for the coin awards.

### DETAILED DESCRIPTION

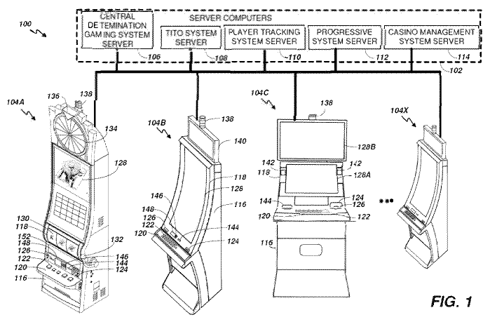

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

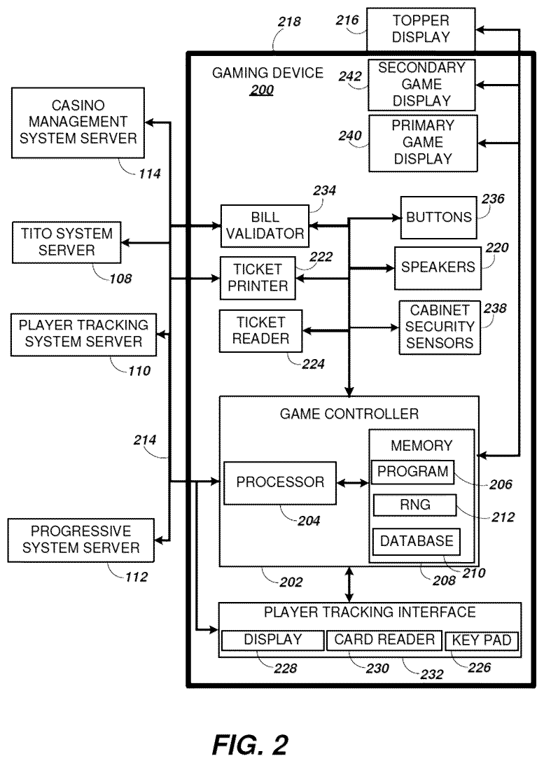

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

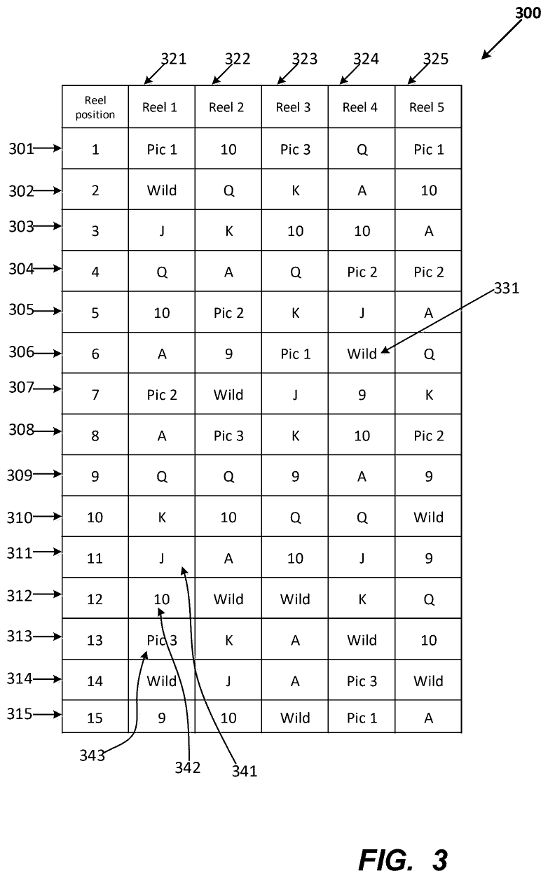

FIG. 3 illustrates an example of a set 300 of five reel strips 341, 342, 343, 344, 345. In the example, each reel strip has thirty reel strip positions 301-330. Each reel strip position of each reel has a symbol. For example, a “Wild” symbol 331 occupies the twenty-eighth reel strip position 328 of the fourth reel 344. Other reels strips to those illustrated in FIG. 3 can be used, for example, reel strips where two or more wild symbols are placed at consecutive reel strip positions of a reel strip. In other examples, the reel strips could have between 30 and 100 reel strip positions. The actual lengths of the game reel strips depend on factors such as the number of wild symbols (in general, the more wilds there are, the longer the reel strip needs to be), and volatility (in general, the higher the prize value is, the longer the reel strip needs to be to lower the hit rate).

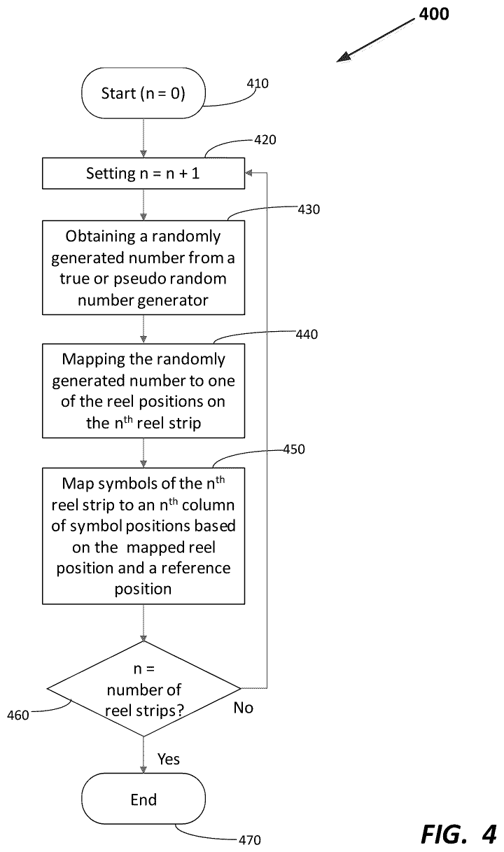

FIG. 4 is a flow chart of a method 400 carried out by the processor 204 to select symbols from reel strips. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions. The reel strips may be of different lengths.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position (and hence the symbol at this position) is mapped to the bottom symbol position of the column. In an example, there are two other symbol positions in the column of symbol positions and hence symbols at two neighbouring reel strip positions are also mapped to the symbol positions of the column. Referring to the example reel strips of FIG. 3, if the value returned by the RNG 212 is mapped to reel position 313, then for the first reel strip 321, “Pic 1” symbol 353 is mapped to a bottom symbol position, “10” symbol 352 is mapped to a middle symbol position, and “Pic 2” symbol 351 is mapped to a top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions.

After the symbols of all reel strips have been mapped to symbol position, the processor 204 controls display 240 to display them at the symbol positions.

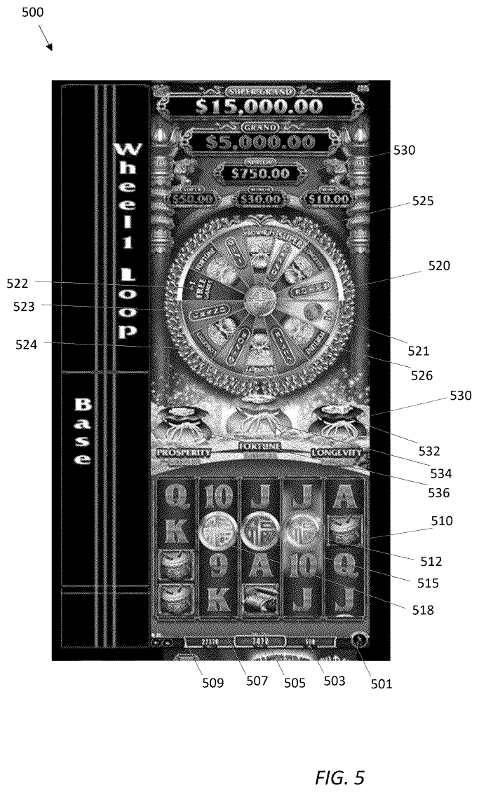

An embodiment of the gaming machine implements a bonus wheel spin feature in a base game. FIG. 5 illustrates an example of a base game display for an EGM, the base game display 500, includes a spinning reel display 510, a wheel 520, and a feature accumulation section 530. Optionally a bonus display section 540 is also provided. In this example the spinning reel display is a 4×5 reel window, displaying four symbols from each of five reels 501, 503, 505, 507, 509. The wheel 520 is divided into a plurality of sectors each sector displaying an indicia associated with a feature or award, in the example shown the wheel 520 has fourteen sectors, two for each of three different features, six for Jackpots of different magnitude, one for a coin award 521, and one for a free game award 522. It should be appreciated that the number of sectors on the wheel, number of spinning reels and number of symbol positions in the reel window may all vary between embodiments.

The feature accumulation section 530 displays, in this example, three visually metamorphic bags 532, 534, 536, each associated with a different feature are displayed above the reel window 510. Each visually metamorphic bag can have a number of states of appearance (for example 5) which are updated independently, based on occurrences of associated scatter symbols in reel spins or wheel spins. The state of the bag can indicate progress toward award of the feature, or that the feature is to be awarded in a feature game. Each time a scatter symbol associated with a bag occurs in a spinning reel outcome, for example a coin 512,515,518 with markings the same color as the bag 532, 534, 536, the game controller will increment a count stored in memory or a hardware meter of the gaming machine the feature. State of the appearance of the visually metamorphic bag 532, 534, 536 is based on this count, for example showing the bag filling with coins as these occur in the game outcome. A final state, for example the bag changing color and/or appearance indicates the feature is triggered to be awarded in the feature game once initiated. In some embodiments the metamorphic bag may also be rendered having a different appearance if the feature is to be awarded in an extreme state.

In the example shown in FIG. 5. Each time a scatter symbol (SCAT) appears a SCAT animation may play showing the coin tracking from the display position of the SCAT symbol to the corresponding bag above, portraying a visual accumulation of SCAT's in the bag. In some embodiments this animation can play immediately the SCAT symbols is displayed. Each bag in this example has 5 states which are updated based on how many SCAT's of that kind appeared in the reel window since the corresponding feature was last awarded.

In embodiments of the invention the reels are dynamically configured with scatter symbols before each round. The number of scatter symbols occurring on each reel is based on the state of the bag or wheel. An example of a state table is shown below in table 1. It should be noted that the scatter symbols are added when configuring the reels based on the current bag state. The count for each bag is reset after the feature it corresponds to is awarded. The count for each bag may also be reset at the start of game play by a new player.

TABLE 1

| State of bag | BAG1 | BAG2 | BAG3 | Wheel |
|---|---|---|---|---|
| 1 | 0-4 | 0-4 | 0-4 | 0-3 |
| 2 | 5-9 | 5-9 | 5-9 | 4-7 |
| 3 | 10-14 | 10-14 | 10-14 | 8-12 |
| 4 | 15-24 | 15-24 | 15-24 | 13-19 |
| 5 | 25+ | 25+ | 25+ | 20+ |

In an embodiment the reels carry a dynamic scatter symbol or scatter symbol place holders which become the specific scatter symbol (i.e. SCAT1, SCAT2, SCAT3 or SCAT4) at the start of each spin.

In this example, with reference to FIG. 5, SCAT1 518 Corresponds to BAG1 536 and may award Feature 1. In this example Feature 1 is a reel growth feature labelled a “prosperity” feature, and the symbol SCAT1 518 is a coin with a colour or pattern the corresponds to the colour of bag 1 536. SCAT2 512 corresponds to BAG2 534 and may award Feature 2. In this example Feature 2 is an upgrade feature labelled a “fortune” feature, this feature can cause an increase in value or state transition for coins in the feature game. The symbol SCAT2 512 is a coin with a colour or pattern the corresponds to the colour of bag 2 534. SCAT3 515 corresponds to BAG3 532 and may award Feature 3. In this example Feature 3 is a free spin feature labelled a “longevity” feature. The symbol SCAT3 515 is a coin with a colour or pattern the corresponds to the colour of bag 3 532. In the example embodiment none of these scatter symbols have any payable credit award associated with their occurrence, however the award of features via the scatter symbols impacts the volatility of awards during feature game play.

SCAT4 810 Corresponds to the Wheel 520 and may award the Wheel Bonus, where wheel spins can increment count for each of the triggerable features (Features 1-3), accumulate free reel spins for the feature game or award prizes such as bonus prizes or accumulate coins. The wheel bonus can provide wheel spins until at least one feature is triggered and the bonus spins end when the feature game is started. This wheel scatter symbol has no payable credit award associated with its occurrence, however a credit award may be made as a result of wheel spins.

In the embodiment shown the key scatter symbols (SCAT1-4) are visually similar but identifiable to the individual bags and the wheel. This visual similarity aids player interpretation of the scatter symbols and understanding of the game state.

The reels can also configured to include:
WILD symbols which may substitute for any symbol except the scatter symbols to make a winning symbol combination.
Picture symbols, for example 1-5 picture symbols reflecting a game theme.
Symbols for forming winning symbol combinations, for example playing card type symbols (A, K, Q, J, 10, 9), fruit or other conventional type reel symbols.

STACK symbols on all reel strips, are replaced during reel configuration by picture and symbols combination symbols (i.e. A, K, Q, J, 10, 9) based off a weight table. Weight tables are provided for each of the base game and each of the feature games. Weight tables are configurable by the game designer to manipulate probabilities for occurrences of game events, such as occurrence of winning combinations, feature awards and feature triggers. Whether or not a feature is triggered is based on a combination of the symbol count, a weight table and random result. By virtue of the weight table, the volatility and RTP of the gaming machine may be adapted independently of the game play execution program code. This has advantages for gaming machine deployment and reliability as the core operation of this gaming machine need not be altered to adjust volatility, only alteration of the weight tables.

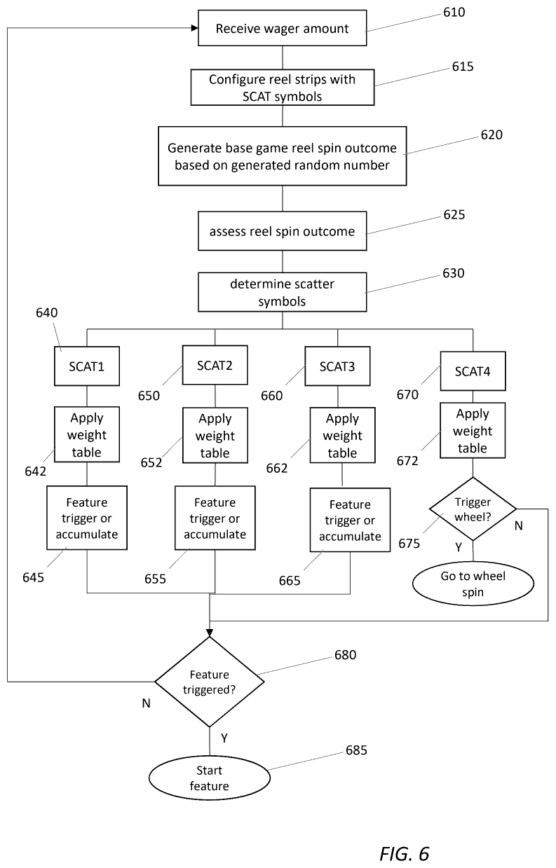

Looking at an example of the gaming machine and method of operation in further detail, FIG. 6 is a flowchart of a method 600 carried out by the processor for operation of the EGM for a game play sequence for a base game. A player initiates game play by inputting a wager amount at step 610 the wager amount is received. In the example shown in FIG. 5 the base game has a reel window with 50 win lines playable, and a player may select a wager denomination or credit wager per line from options provided using buttons on the player interface. Different reel window sizes and number of reels may be applied in different embodiments.

At step 615 the reel strips are configured (as discussed above) for the initial base game round with the number of scatter symbols of each type based on the wagered amount, and a base game weight table. At step 620 the processor selects a plurality of symbols from the configured reels using the random number generator similarly to as discussed above in relation to FIG. 4, and controls the display to display the selected symbols as a reel spin outcome in a plurality of columns of display positions. Where a wager is above a threshold, features may be triggered in a boosted (also referred to as extreme state) where improved rules are applied during feature game play. The improved rules having the effect of increasing probability of high value awards being made in the feature game play.

At step 625 the processor assesses the reel spin outcome to identify any prize winning combinations of symbols in the reel spin outcome, and update a win meter with credits awarded.

The processor also determines whether any scatter symbols are included in the reel spin outcome 630, and executes a subroutine to assess a trigger condition for each scatter symbol occurrence. When the scatter symbols SCAT1 518, SCAT2 512, SCAT3 515 appear in the reel spin outcome there is a weighted chance the associated feature is triggered. Trigger weights differ in different weight tables based on the combination of scatter symbols landing in the reel spin outcome and feature accumulation (bag) state, for example a boost state.

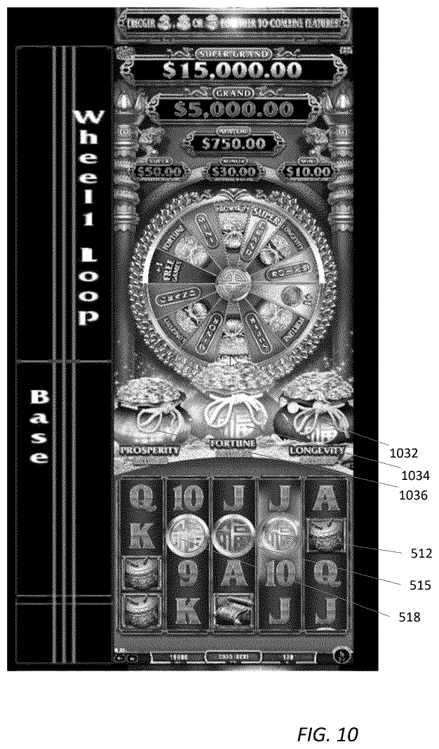

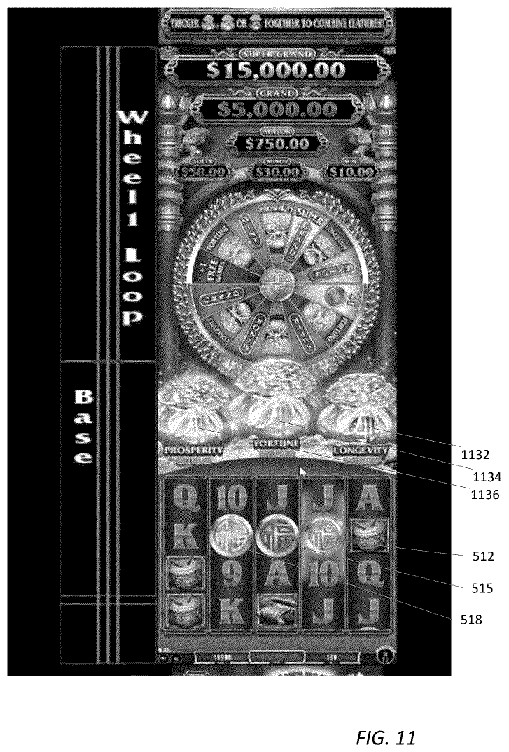

For each game play feature associated scatter symbol occurrence (SCAT1-SCAT 3), the processor assesses a trigger condition for the game play feature based on the applied weight table and a random number generator output. The weight table sets a probability for the trigger which in combination with a RNG output determines whether or not a feature is triggered. It should be appreciated that the feature will not trigger for every occurrence of the scatter symbol in a game outcome.

Where the feature is not triggered the scatter occurrence counter for the feature is incremented, and if the count meets a criteria for state transition the feature state is incremented. In some embodiments as the feature counter is incremented a further instance of the scatter symbol is added to the reels as these are configured for the next reel spin.

Where scatter symbols for more than one feature occur in the same reel spin outcome, whether to trigger both features for a combined feature game is also determined based on the weight table. The outcome of the trigger assessment has the options of 1) no feature being triggered, 2) only one of the features being triggered for a feature game, 2) two features triggered for a super feature game wherein feature game play includes game play characteristics of both triggered features or 4) all three features triggered for a mega feature game including game play includes game play characteristics of all features.

Where the trigger condition is met the processor provides an indication that the game feature is to be awarded, for example by altering the visually metamorphic bag associated with the feature. For example, an animation showing a scatter symbol flying to and entering the corresponding feature accumulation bag is shown on occurrence of the symbol. If the feature is triggered, the displayed bag symbol will be visually altered, for example to change color (i.e. gold) or pattern, move (i.e. spin or shake), grow in size, and a trigger sound may also be played. If multiple features are triggered each bag may animate individually. FIG. 10 and FIG. 11 illustrate non triggered (FIG. 10) and triggered (FIG. 11) bag states.

Where the feature is triggered from the reel spin game outcome, without a wheel spin also being triggered, the processor will cause the game machine operation to enter the feature game play mode, for a feature game which includes the triggered game play features.

Where a wheel spin scatter symbol also occurs, the triggered features will hold their triggered state until completion of when spin trigger determination and, if triggered, the wheel spin. It should be appreciated that the wheel spin may result in an additional feature being triggered or upgrade of a triggered feature to an extreme state, wherein improved feature game play rules are applied for the feature in the feature game.

The base game wheel spin feature is triggered based on a random chance when a special symbol (wheel spin scatter symbol SCAT4 810) appears on the reels in an outcome of a base game reel spin. Referring to FIG. 6. when the wheel spin scatter symbol (SCAT4) occurs in the reel spin outcome 670, the processor applies the weight table and a RNG output in a trigger determination process 672 to determine whether or not the wheel spin is triggered 675. If the wheel spin is not triggered, if a feature is triggered 680 the game controller process continues to execute the feature game 685 with any triggered features. If no feature game is triggered the game sequence returns to the player to initiate subsequent game rounds. The feature accumulation counts and states persist for the subsequent game rounds.

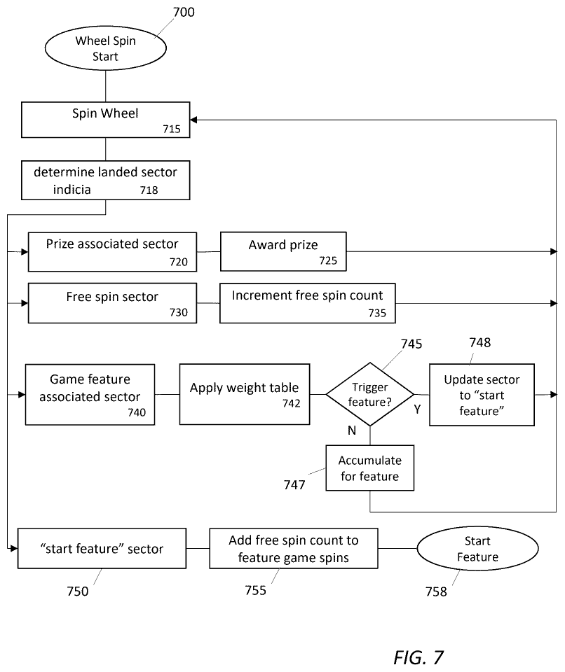

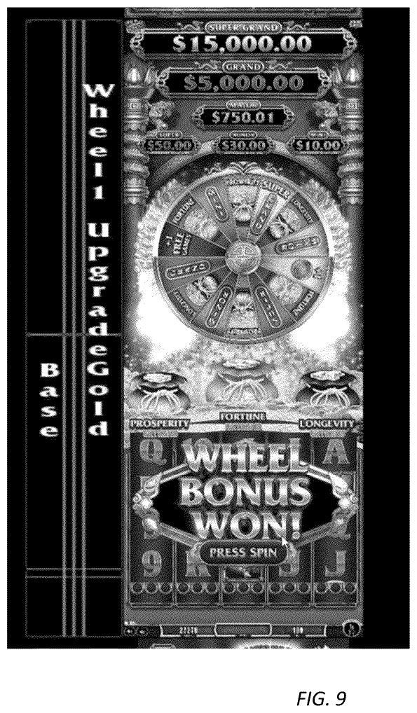

If the base game bonus wheel spin feature is triggered, 675 the game controller starts the wheel spin feature. An example of an announcement for triggering of the base game wheel spin feature is shown in FIG. 9. An example of a method implemented by the process for execution of the wheel spin feature is provided in the flowchart of FIG. 7.

The game controller will continuously award reel spins until a trigger condition is met. In an example the trigger condition is a “Start Feature” being awarded in a reel spin. Alternatively, a number of wheel spins may be awarded, and any won feature triggered at the conclusion of the reel spins. In an embodiment a number of wheel spins is determined (either predetermined or determined based on an output from the RNG at the time of triggering the wheel spins) and a final wheel spin controlled to indicate selection of a “Start Feature” wheel sector at the conclusion of the determined number of reel spins.

In an embodiment the game controller may be configured to ensure that at least one feature is awarded from the reel spins, such that a feature will always be awarded at the end of the wheel spins.

The bonus wheel is displayed divided into a plurality of sectors, each sector displaying indicia associated with an action or award. In an embodiment possible wheel prizes include jackpots/bonuses, feature triggers, extra games and extra coins associated with awards.

With reference to FIG. 7. the wheel spin feature starts 700 the wheel is displayed to “spin” 715 and the processor select a wheel sector based on an output of the random number generator, the wheel is displayed to land on the selected sector 718. The landed sector indicia indicate the prize or feature associated with the landed sector 718.

When a wheel spin results in a prize sector 720, the indicia indicate a jackpot or bonus prize to be jackpot/bonus awarded 725. The processor updates the win meter to awarded a credit amount payable for the indicated jackpot. For example, in the embodiment shown in FIG. 5, the awards include 3 progressives (Super, Grand, Major), and 3 bonus prizes (Super, Minor, Mini). In an embodiment, award of a jackpot prize is not a termination criterion for the wheel spins, so does not terminate the game play and the player can continue to spin the wheel until a trigger condition is met. A prize sector may also include a fixed value prize.

The wheel can include a +X coin sector. In the example of FIG. 5, this sector 521 shows +1 bronze coin. When the wheel lands on this sector 521, +X bronze coins are awarded, that number of bronze coins will reveal a credit prize and fly down to a random bucket beneath one of the reels. The segment will upgrade to a higher number of bronze coins and the player will continue to spin.

The wheel can include a free game sector 522, and landing on this sector 730, causes the game controller to increment a free spin count 735 for the feature game based on a number of free spin indicated on the sector indicia. In an embodiment the number of free spins awarded can be fixed (i.e. +1 free spin) or variable. In an embodiment the number of free spins awardable is incremented after each free spin award. In an alternative embodiment the number of free spin awardable is based on a random selection, for example random selection from a set of free spin options (for example 1, 2, 3, 5 or 10 free spins). The wheel spin awarded free spins are added to a number of free spins initially allocated for the feature game. The processor will then trigger a further wheel spin.

Where the selected sector is associated with one of the game features 740, the game controller assesses a trigger condition for the game play feature based on a weight table 742 and a random number generator output, and where the trigger condition is met 745, the game controller provides an indication that the game feature is to be awarded and modifies the selected sector to become associated with a start feature trigger 748. Where the feature is not triggered 745, the accumulation count for the feature is incremented 747. An accumulation state/bag state may also be upgraded if the increment meets an upgrade threshold. The processor will then trigger a further reel spin.

When feature triggers are awarded, the bag corresponding to that feature will enter its triggered state, segments with that feature on it will be replaced with “Start Feature” wheel spins will continue (initiated by the player or automatically by the processor) as described above until a “start feature” sector is selected 750.

When “Start Feature” is awarded, player will be awarded the combination feature correlating to all feature triggers collected along with any of the upgrades collected.

When the start feature sector is selected the accumulated +Y free games will be added to the allocated number of free games for the feature game play. For example, the feature game may have a default number of game rounds awarded The feature game play will proceed with the features triggered from the reel spins and wheel spins.

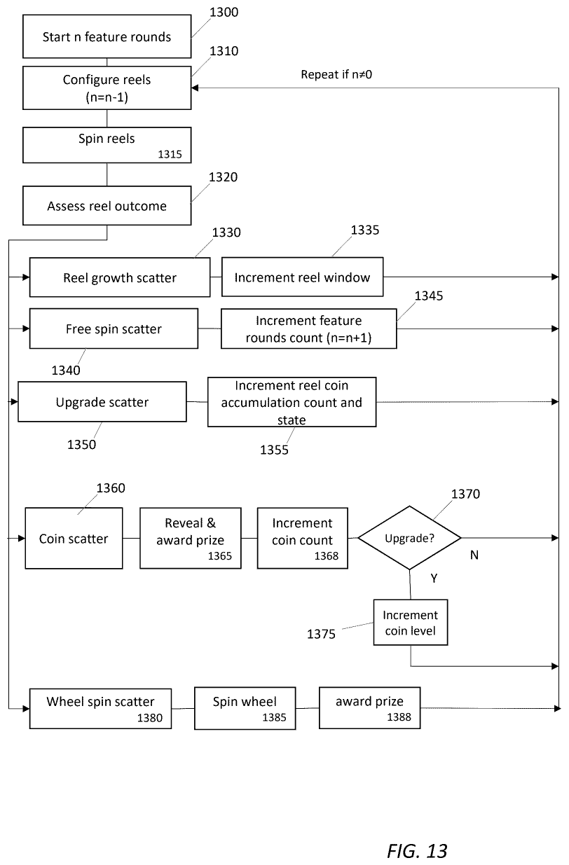

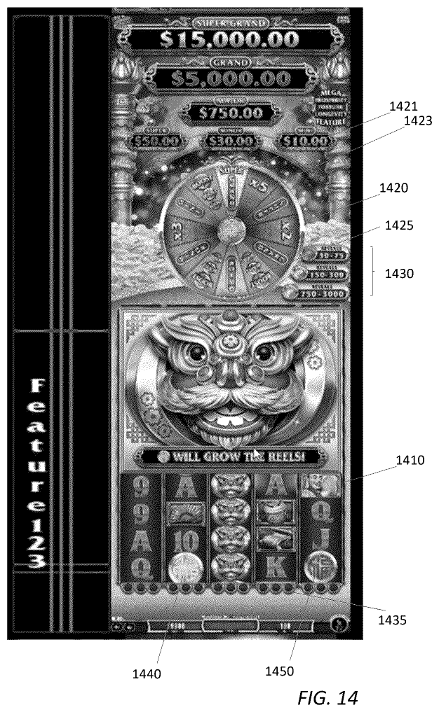

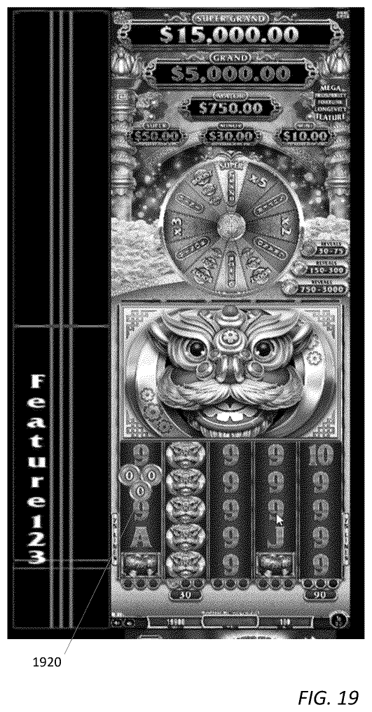

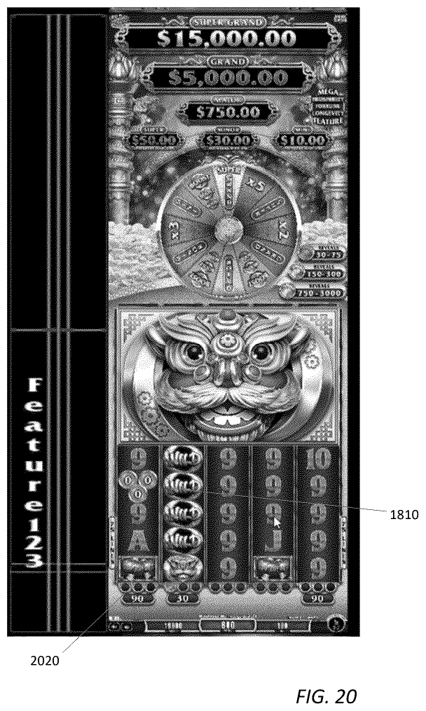

A flowchart of an example of a process executed by the processor for a feature game is shown in FIG. 13, with images of examples of the gaming machine GUI at different stages of play illustrated in FIGS. 14-25, which show an example of an extreme state of the feature game with all features triggered.

The feature game play includes spinning reels 1410 and a spinning wheel 1420. The spinning wheel is divided into a plurality of sectors, and each sector respectively associated with any one of an award 1421 (i.e. a progressive jack pot or bonus award), multiplier 1423 or boost feature 1425.

In the feature game only the awarded game play features at the time the feature game was triggered will be included in the feature game play. It should be noted that feature game play may be triggered including any one or more of the game features. In the example shown, all features are applied in the feature game rounds. In this example these include a reel growth (prosperity) feature, an upgrade (fortune) feature, and a free spin (longevity) feature, also a wheel spin feature.

On initiation of the feature game the game controller executes game program code to determine a number of reel spins for the feature, in the example shown the number of reel spins n is the sum of an allocated number of game rounds for the feature (this may be defined or determined using an RNG output), and the number of additional free games awarded during base game play. For example, in the embodiment shown 8 reel spins are allocated for the feature and if 3 free spins were awarded from base game reel spins, then the feature game will set n=11 as the number of reel spins. For each round the game controller will decrement a remaining reel spin counter by 1, and feature game reel spins are executed until n=0.

On initiation of the feature game, the game controller also selects one or more weight tables to apply for the feature game based on the triggered features, any boost states and optionally credit wagered in the base game, including any ante-bet.

For each round the game controller also configures reels for the feature game. To configure the reels only the feature scatter symbols associated with the features triggered for the feature game are available to include in the reels. Other scatter symbols available in all feature game rounds are wheel scatter symbols (SCAT4) and coin scatter symbols (SCAT5). The game controller configures the reels such that at least one of each of the available scatter symbols is allocated on at least one of the reels.

For each reel, a counter 1435 with a set number of slots (i.e. 3) is displayed associated with each reel (for example at the bottom of the reel). As coin scatter symbols occur on the reel in a reel spin outcome a prize associated with the coin is displayed and awarded. The prize value associated with the coin is based on the coin type/color (i.e. bronze, silver or gold) and a prize value range 1430 associated with each coin type. The coin type/color indicative of a value progression.

The coin counter is also updated to represent the addition of each coin occurring on the reel for the game outcome. When the displayed slots are full, the counter state is upgraded, to the next level and to match the next color in the value progression. In some embodiments the coin scatter symbols allocated to each reel will correspond to the counter level and color. Credit prizes allocated can also be displayed accumulated for each reel to be awarded at the end of the feature game play.

To execute a reel spin 1315 the game controller selects a plurality of symbols from the configured feature game reels to display in the columns of display positions of the reel window. The selection can be based on a stop position for each of the reels determined based on a random result output by the RNG. The game controller then assesses the displayed outcome to determine occurrence of any award winning symbol combinations, and scatter symbols.

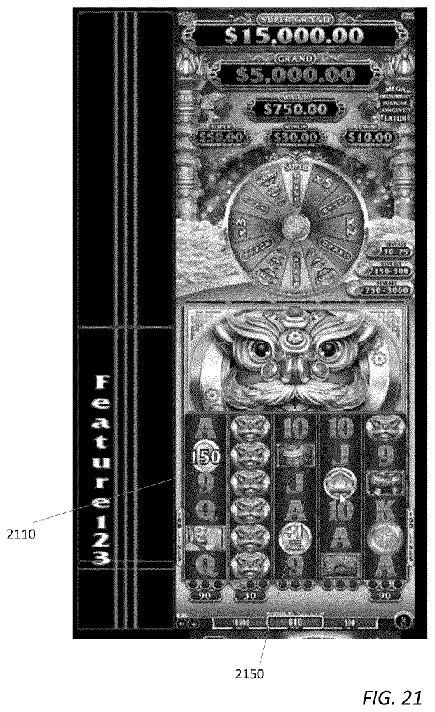

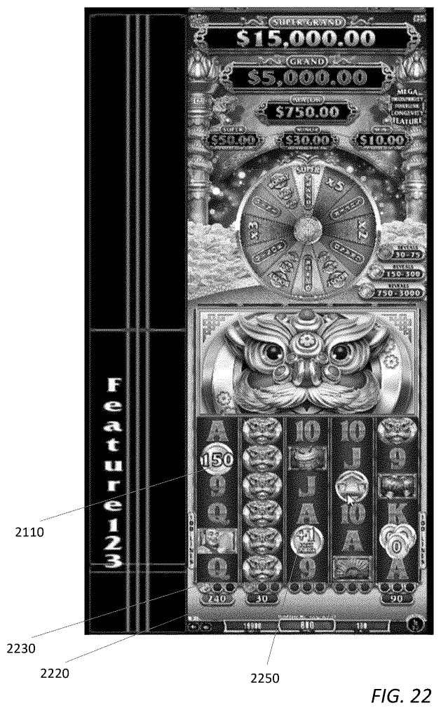

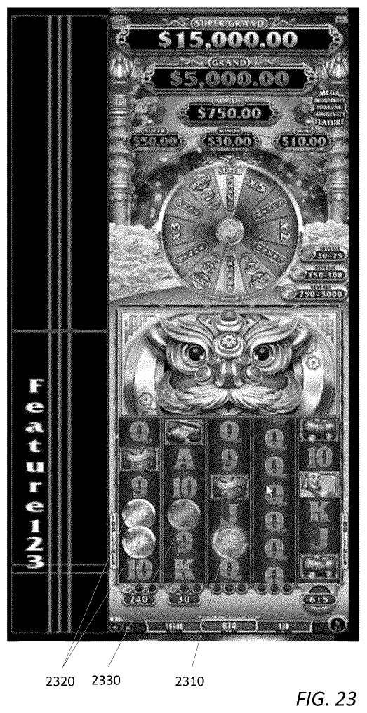

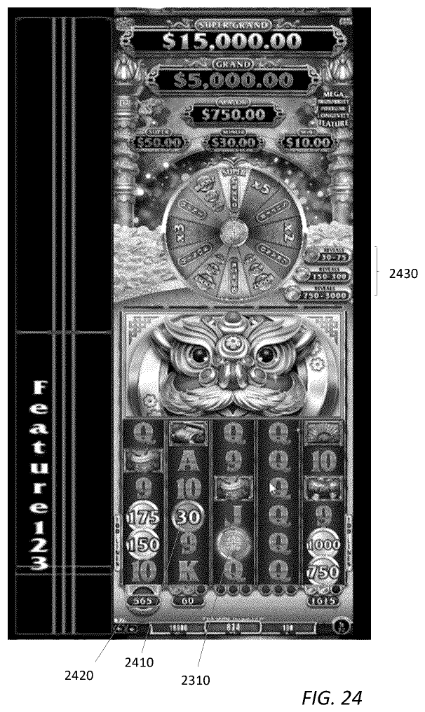

For each game play feature associated scatter symbol occurrence, the processor executes the game play feature function based on a weight table and a random number generator output.

Where a scatter symbol occurrence is a coin accumulation scatter symbol 1360, the game controller processor determines an award value 1365 for the occurrence based on a coin accumulation state of the of the reel (for example as indicated by the counter). The type of coin scatter symbol (i.e. bronze) may be associated with a fixed credit value (say 20 credits) or a credit value range set for that symbol type. Where a credit value range is used the actual value from within that range associated with the symbol may be determined based on a random result. ion a coin counter value for the reel. The coin counter for the reel is incremented 1368 and if all slots are full, the coin counter level for the reel is upgraded to the next level 1375. FIG. 21 shows an example of a reveal of a credit award associated with a coin scatter symbol 2110, and FIG. 22 shows an example of the display after accumulating the award 2220 and incrementing the coin counter 2230. The first reel is in an upgraded stat such that silver coins appear on this reel, and the counter shows 2230 shows one silver coin collected and the credit value accumulated updated to 240 credits, from 90, by the addition of the 150 credits awarded for the silver coin 2110. FIGS. 23 and 24 also show an example of silver 2320 and bronze 2330 coins value reveal. FIG. 24 also shows the counter 2340 is upgraded to gold and no longer includes coin slots as no further upgrades are possible for this reel.

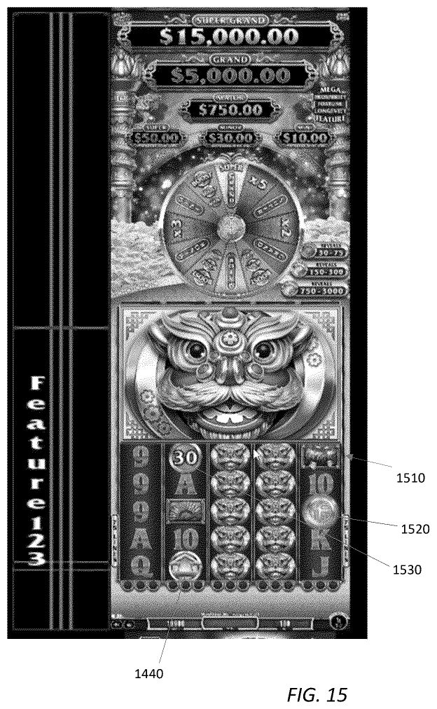

With reference to FIGS. 14 and 15, for each occurrence of a reel growth scatter 1440, 1330 the reel window is incremented 1335 by at least one row 1510. In some embodiments the game controller processor may determine growth of more than one row (for example 2 rows) based on a random result, for example where the feature is triggered in a boosted or extreme state the feature may have a chance of awarding 1 or 2 additional rows based on a random result. The extended reel window will persist for the remaining duration of feature game play. It should be appreciated that with each additional row, more win lines are available, thereby increasing probability of occurrence of winning symbol combinations or scatter symbols in subsequent reel outcomes. In the example shown for a 5 reel embodiment each additional row added to the reel window results in 25 more win lines being added for the remainder of the feature game play. Thus, increasing probability of further award of prizes of features in subsequent reel spins.

In an embodiment reel height increase will be applied before assessing any win line awards. Thus, the reel spin outcome is modified to add the symbols of the new row. The symbols of the additional row are added to the game outcome based on the reel configuration and stop position for the game outcome. In this embodiment any scatter symbols or awards revealed by the reel growth will be assessed as if these occurred in the original reel outcome. If an additional reel growth scatter symbol is revealed, a further additional reel will be added, and this modified game outcome assessed. FIG. 15 shows an example of a value for a coin scatter symbol 1530 being revealed and awarded as a result of the occurrence of the reel expansion symbol 1440.

In an embodiment a maximum reel window height is set. For example, a maximum of 10 rows may be able to be added. The maximum number of row increases may vary between embodiments. The maximum additional rows may be based on display area for the feature reel window. Once the maximum number of additional rows have been added, the reel growth scatter symbol may be removed from the available scatter symbols for configuring reels.

Where a free spin scatter symbol 1450 appears on the reels 1340, an additional wheel spin is awarded. The reel spin counter will be incremented 1345 to add an additional reel spin. An example of the free spin award reveal 2250 is shown in FIG. 22. If the feature game is triggered in an extreme state, more than one additional reel spin may be awarded, based on a random chance. For example, one or two fee games may be awarded.

For each occurrence of an upgrade scatter symbol 1350, 1520, may cause an upgrade in reel state for the reel of the symbol occurrence 1355. In an embodiment at least one prize scatter symbol associated with a potential reel state upgrade replaces the upgrade scatter symbol on the reel of the upgrade scatter symbol occurrence. For example, the upgrade symbol may be replaced by a symbol that causes a counter increment, and reels upgraded based on the count meeting a threshold value. In an alternative embodiment the upgrade scatter symbol may directly trigger a reel state or level upgrade.

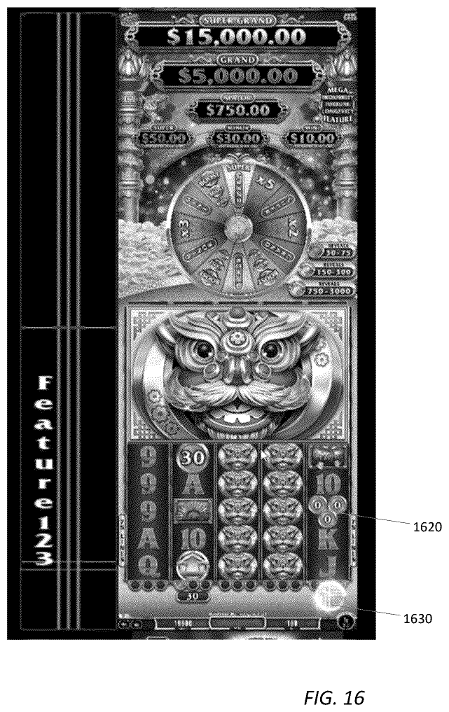

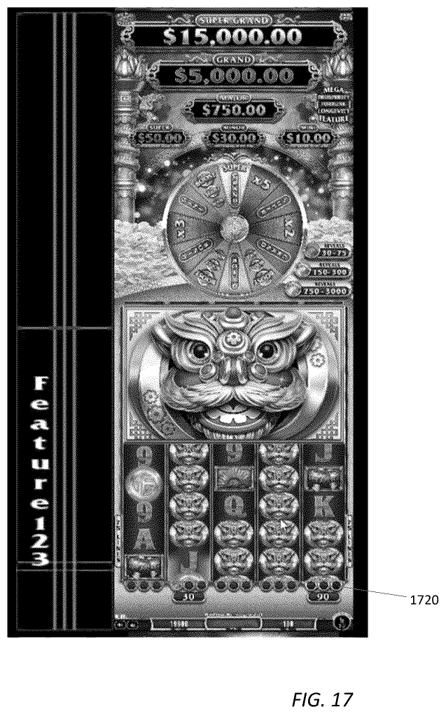

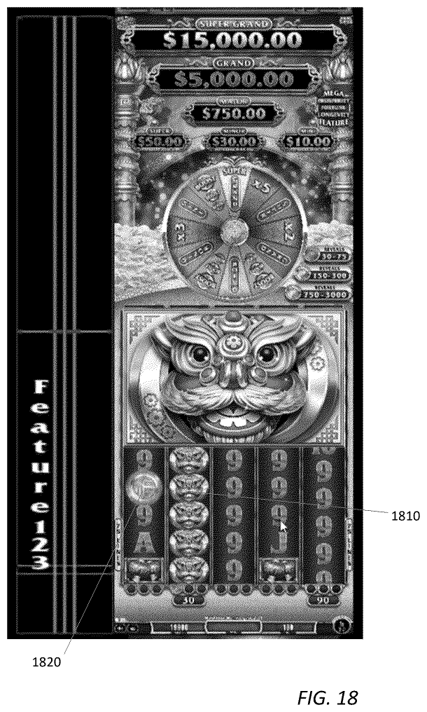

In the example shown in FIGS. 15 and 16, the upgrade scatter symbol 1520 is a special coin 1520, which is displayed substituted for three bronze coins 1620, which are treated as coin accumulation symbols and added to the coin counter for reel 1630. As the coin counter has only 3 slots, the addition of the three coins causes the counter to update to the next level, in this case silver 1720, from bronze, as shown in FIG. 17. Thus, this feature can enable increased rate of progression though reel states. Where the feature is triggered in an extreme state, the number of coins awarded may be 3 or 6 based on a random chance. A further example is shown in FIGS. 18 to 20, where the upgrade scatter symbol 1820, reveals three bronze coins of zero credit value 1920, which are counted to upgrade the reel to silver coin level 2020.

Where a reel has reached its maximum upgrade state, the upgrade scatter symbols is no longer available for that reel, and removed from that reel when the reel is configured for subsequent spins. FIG. 24 shows an example of the counter 2420 upgraded to the gold state, without coin slots.

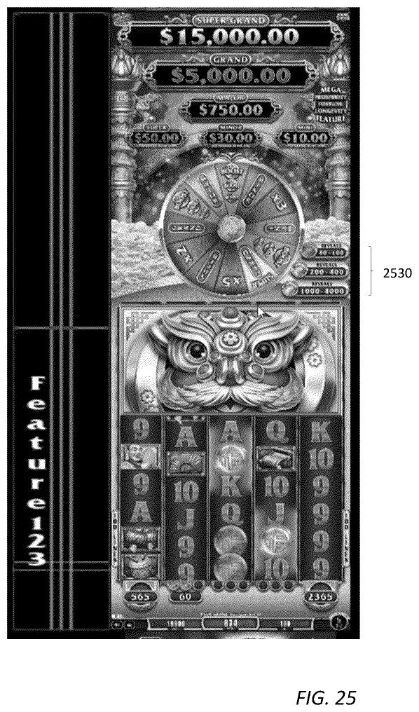

For each occurrence of a wheel spin scatter symbol 1380, a wheel spin 1385 is executed to select a sector based on a random number generator output. The award, multiplier or boost feature associated with the selected sector is then applied 1388. For example, where the award is a jackpot or bonus, this may be applied instantly by addition of credits to a credit meter. Where the award is a multiplier, the multiplier is applied to multiply prize values accumulated associated with each of the reels at the time of the wheel spin.

Where a wheel spin selection lands on the boost segment the vale range for coin awards is increased. For example, in FIG. 24, the value ranges for coin awards 2430 are 30-75 for bronze, 150-300 for silver and 750-3000 for gold, and in FIG. 25 after selection of the boost segment from the reel spin the coin award ranges 2530 are 40-100 for bronze, 200-400 for silver and 1000-4000 for gold. In this example both the starting value and size of the range associated with each coin is increased. In an embodiment only the starting value for each range may be increased, with the size of the ranges remaining the same. The new range for coin symbols will be applied for the subsequent reel spins and can persist until the end of the feature game or updated by a further boost.

The wheel spin will be executed after all other awards and features applicable for the reel spin have bene applied. For example, as illustrated in the sequence of FIGS. 23 and 24, a wheel spin scatter symbol 2310 occurs in the reel spin outcome, and awards associated with the coin symbols 2410, 2420 are revealed first, before the wheel spin is executed.

It should be appreciated that in the present invention dynamic reel configuration for each reel spin provides a first mechanism for manipulating game award probabilities and volatility, by allocation of the award scatter symbols and feature trigger symbols. Further use of weight tables and random chance in relation to triggering of features provides a second mechanism for manipulating award probabilities and game volatility. In other words, the feature being triggered is not based solely on the occurrence of the associated scatter symbol in the reel game outcome, the determination of the trigger condition is based on the weight table and a RNG output. The probability of a game feature being triggered is therefore the compound probability of both the first and second mechanism. It should be appreciated that the first mechanism is dependent on the game program code, and operation of programmed subroutines. The second mechanism is dependent on the defined weight table. A plurality of weight tables may be stored in the game controller memory, selectable during execution of the game code for application in the second mechanism. This enables game probabilities to be manipulated by alteration of the weight tables alone, without otherwise affecting the game program executable by the gaming machine. Thus, where probabilities or volatility may need to be altered (for example for regulatory compliance or preference) this may be achieved though alteration of the weight tables only, without otherwise affecting the gaming machine operation. Thus, burden of testing and verification of gaming machines adapted for different jurisdictions can be reduced, as the underlying gaming machine operation is not altered where only weight tables are modified to manipulate game play probabilities. This ability to decouple one mechanism for probability manipulation can enable a greater proportion of game operation to be implemented in hardware or firmware for higher speed operation than in software program code.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

Clause 1: A gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with at least one wheel sector associated each of the different game play features, and at least one wheel sector associated with each one of a plurality of awards, and indicia for display in each respective wheel sector represent the sector association, and (v) one or more weight tables, and wherein the game controller is operable to assign prize values based on random outcomes as required during play of the game, the game controller executing the game program code stored in the memory and responsive to initiation of the play of the game with the game play mechanism to: configure the reels by replacing each instance of the dynamic scatter symbols of the reels with one of two or more of the feature associated scatter symbols; select a plurality of symbols from the configured reels using the random number generator, and control the display to display the selected symbols in a plurality of columns of display positions to generate a reel spin outcome; make an award of credits to the win meter or the credit meter based on any prize values assigned to combinations of symbols in the reel spin outcome; review the reel spin outcome to determine any occurrence of a feature associated scatter symbol, wherein: for each game play feature associated scatter symbol occurrence, assess a trigger condition for the game play feature based on a weight table and a random number generator output, and where the trigger condition is met provide an indication that the game feature is to be awarded; for an occurrence of the wheel feature associated scatter symbol trigger a wheel spin to select a wheel sector based on an output of the random number generator, wherein selecting a sector associated with a prize award causes an award of credits to the win meter or the credit meter based on the prize; selecting a sector associated with one of the features causes assessment of a trigger condition for the game play feature based on a weight table and a random number generator output, and where the trigger condition is met provide an indication that the game feature is to be awarded and modifying the selected sector to become associated with a start feature trigger; and selecting a sector associated with a start feature trigger will cause start of a feature game wherein the game features to be awarded triggered from the spinning reel and wheel are provided in the feature game, and wherein wheel spins are repeated until selection of the start trigger sector.

Clause 2: A gaming machine as described in clause 1 wherein the game play feature associated scatter symbols include: a reel growth scatter symbol associated with a reel growth feature, wherein an extra row is added to a reel window for each occurrence of the reel growth scatter symbol in a feature game outcome; a free game scatter symbol, wherein for each occurrence of the free game scatter symbol at least one additional feature game round is awarded; an upgrade scatter symbol, wherein for each occurrence of the upgrade scatter symbol at least one prize scatter symbol associated with a potential reel state upgrade replaces the upgrade scatter symbol on the reel.

Clause 3: A gaming system as described in clause 2, wherein the plurality of awards associated with wheel sectors include any one or more of: one or more bonus prizes; one or more free games; one or more coin accumulation increments.

Clause 4: A gaming machine as described in clause 3, wherein each reel has an associated coin accumulation indicator having a plurality of states, each state being associated with an increase in coin value and wherein state transition is based on a coin accumulation count.

Clause 5: A gaming machine as described in clause 4 wherein the coin accumulation indicator has three states.

Clause 6: A gaming machine as described in clause 4 wherein feature game play includes spinning reels and a spinning wheel, the spinning wheel having a plurality of sectors, each sector respectively associated with any one of an award, multiplier or boost feature, and when feature game play is triggered the game controller executes game program code to determine a number of rounds of feature game play and a weight table for the feature game play, and for each round: configure the feature game reels to include at least one game play feature associated scatter symbol for each of the game play features to be awarded, at least one wheel feature associated scatter symbol, and at least one coin accumulation scatter symbol; select a plurality of symbols from the configured feature game reels using the random number generator, and control the display to display the selected symbols in a plurality of columns of display positions to generate a feature game reel spin outcome; review the reel spin outcome to determine any occurrence of a feature associated scatter symbol, wherein: for each game play feature associated scatter symbol occurrence, execute the game play feature function based on a weight table and a random number generator output; for each coin accumulation scatter symbol determine an award value for the occurrence based on a coin accumulation state of the of the reel; and for each occurrence of a wheel spin scatter symbol, a wheel spin is executed to select a sector based on a random number generator output, and applying the award, multiplier or boost feature associated with the sector, and wherein reel spins repeated until the number of feature spins have been executed.

Clause 7: A gaming machine as described in clause 6 wherein the boost feature causes an increase in credit value ranges associated with each coin state.

Clause 8: A gaming machine as described in clause 6 wherein awards associated with spinning reel sectors include a plurality of bonus awards.

Clause 9: A gaming machine as described in clause 7 wherein the trigger outcome of an assessment of a feature trigger will be one of a) trigger condition not met, b) trigger condition met, and c) trigger condition met and an extreme state applied for the feature game, wherein in the extreme state, operation of game features is based on an extreme state weight table and random number generator output, whereby volatility of feature awards is varied in the extreme state.

Clause 10: A gaming machine as described in clause 9 wherein the extreme state is only applicable if the all game play features are to be awarded in the feature game rounds.

Clause 11: A method of operating a gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with one wheel sector associated with a start feature trigger, and each other sector associated with one of the different game play features or one of a plurality of awards, and indicia for display in each respective wheel sector represent the sector association, and (v) one or more weight tables, and wherein the game controller is operable to assign prize values based on random outcomes as required during play of the game, the game controller executing the game program code stored in the memory and responsive to initiation of the play of the game with the game play mechanism, the method comprising the steps of: configuring the reels by replacing each instance of the dynamic scatter symbols of the reels with one of two or more of the feature associated scatter symbols; selecting a plurality of symbols from the configured reels using the random number generator, and control the display to display the selected symbols in a plurality of columns of display positions to generate a reel spin outcome; making an award of credits to the win meter or the credit meter based on any prize values assigned to combinations of symbols in the reel spin outcome; reviewing the reel spin outcome to determine any occurrence of a feature associated scatter symbol, wherein: for each game play feature associated scatter symbol occurrence, assess a trigger condition for the game play feature based on a weight table and a random number generator output, and where the trigger condition is met provide an indication that the game feature is to be awarded; for an occurrence of the wheel feature associated scatter symbol trigger a wheel spin to select a wheel sector based on an output of the random number generator, wherein selecting a sector associated with a prize award causes an award of credits to the win meter or the credit meter based on the prize; selecting a sector associated with one of the features causes assessment of a trigger condition for the game play feature based on a weight table and a random number generator output, and where the trigger condition is met provide an indication that the game feature is to be awarded; and selecting a sector associated with a start feature trigger will cause start of a feature game wherein the game features to be awarded triggered from the spinning reel and wheel are provided in the feature game.

Cause 12: A method as described in clause 11 wherein the game play feature associated scatter symbols include: a reel growth scatter symbol associated with a reel growth feature, wherein an extra row is added to a reel window for each occurrence of the reel growth scatter symbol in a feature game outcome; a free game scatter symbol, wherein for each occurrence of the free game scatter symbol at least one additional feature game round is awarded; an upgrade scatter symbol, wherein for each occurrence of the upgrade scatter symbol at least one prize scatter symbol associated with a potential reel state upgrade replaces the upgrade scatter symbol on the reel of the upgrade scatter symbol occurrence.

Clause 13: A method as described in clause 12, wherein the plurality of awards associated with wheel sectors include any one or more of: one or more bonus prizes; one or more free games; and one or more coin accumulation increments.

Clause 14: A method as described in clause 13, wherein each reel has an associated coin accumulation indicator having a plurality of states, each state being associated with an increase in coin value and wherein state transition is based on a coin accumulation count.

Clause 15: A method as described in clause 14 wherein the coin accumulation indicator has three states.

Clause 16: A method as described in clause 14 wherein feature game play includes spinning reels and a spinning wheel, the spinning wheel having a plurality of sectors, each sector respectively associated with any one of an award, multiplier or boost feature, and when feature game play is triggered the game controller executes game program code to determine a number of rounds of feature game play and a weight table for the feature game play, and for each round the method further comprises: configuring the feature game reels to include at least one game play feature associated scatter symbol for each of the game play features to be awarded, at least one wheel feature associated scatter symbol, and at least one coin accumulation scatter symbol; selecting a plurality of symbols from the configured feature game reels using the random number generator, and control the display to display the selected symbols in a plurality of columns of display positions to generate a feature game reel spin outcome; reviewing the reel spin outcome to determine any occurrence of a feature associated scatter symbol, wherein: for each game play feature associated scatter symbol occurrence, executing the game play feature function based on a weight table and a random number generator output; for each coin accumulation scatter symbol determining an award value for the occurrence based on a coin accumulation state of the of the reel; and for each occurrence of a wheel spin scatter symbol, executing a wheel spin to select a sector based on a random number generator output, and applying the award, multiplier or boost feature associated with the sector, and wherein reel spins repeated until the number of feature spins have been executed.

Clause 17: A method as described in clause 16 wherein the boost feature causes an increase in credit value ranges associated with each coin state.

Clause 18: A method as described in clause 16 wherein awards associated with spinning reel sectors include a plurality of bonus awards.

Clause 19: A method as described in clause 17 wherein the trigger outcome of an assessment of a feature trigger will be one of a) trigger condition not met, b) trigger condition met, and c) trigger condition met and an extreme state applied for the feature game, wherein in the extreme state, operation of game features is based on an extreme state weight table and random number generator output, whereby volatility of feature awards is varied in the extreme state.

Clause 20: A method as described in clause 19 wherein the extreme state is only applicable if all the plurality of game play features are to be awarded in the feature game rounds.

Clause 21: A gaming machine comprising: a display; a credit input mechanism operable to establish credits on the gaming machine, the credit input mechanism including at least one of a coin input chute, a bill collector, a card reader and a ticket reader; meters configured for monitoring credits established via the credit input mechanism and changes to the established credits due to play of the gaming machine, the meters including a credit meter to which credit input via the credit input mechanism is added and a win meter; a random number generator; a game play mechanism including a plurality of buttons configured for operation by a player to input a wager from the established credits and to initiate a play of a game; and a game controller comprising a processor and memory storing (i) game program code, (ii) symbol data defining reels including dynamic scatter symbols, (iii) further symbol data defining a set of feature associated scatter symbols including a plurality of types of coin scatter symbols each type of coin scatter symbol being indicative of increasing values, and (v) for each reel a coin counter and an associated coin accumulation indicator having a plurality of states, and wherein the game controller is operable to assign prize values based on random outcomes as required during play of the game, the game controller executing the game program code stored in the memory and responsive to initiation of the play of the game with the game play mechanism to: configure the reels by replacing each instance of the dynamic scatter symbols of the reels with a feature associated scatter symbol selected from the set; select a plurality of symbols from the reels using the random number generator, and control the display to display the selected symbols in a plurality of columns of display positions to generate a reel spin outcome; make an award of credits to the win meter or the credit meter based on any prize values assigned to combinations of symbols in the reel spin outcome; review the reel spin outcome to determine any occurrence of a feature associated scatter symbol, wherein: for each occurrence of a coin scatter symbol on a reel: award any credit prize associated with the coin scatter symbol by award of credits to a win meter; increment the coin counter associated with the reel; assess a current reel state in relation to the incremented coin counter to determine whether a trigger condition for reel state transition is met for the reel; and update display of the coin accumulation indicator to visually indicate the incremented coin count and any determined new reel state.

Clause 22: A gaming machine as described in clause 21, wherein each reel state is associated with a type of coin scatter symbol.

Clause 23: A gaming machine as described in clause 22, wherein for each reel during reel configuration only the type of coin scatter symbol corresponding to the reel state are selected for the reel.

Clause 24: A gaming machine as described in clause 23, wherein two or more types of coin scatter symbol are associated with prize ranges, and a credit prize for the symbol is selected from within the range associated with the symbol.

Clause 25: A gaming machine as described in clause 24, wherein a boost feature causes an increase in the prize ranges associated with the coin scatter symbols.

Clause 26: A gaming machine as described in clause 23, wherein the coin accumulation indicator has three states.

Clause 27: A gaming machine as described in clause 26 wherein the trigger condition for reel state transition is accumulation of three coins of the type corresponding to the reel state and the coin accumulation indicator includes three coin slots to visually indicate progression to the next reel state transition.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. A gaming machine comprising:
a display;
a credit input mechanism operable to establish credits on the gaming machine, the credit input mechanism including at least one of a coin input chute, a bill collector, a card reader and a ticket reader;
meters configured for monitoring credits established via the credit input mechanism and changes to the established credits due to play of the gaming machine, the meters including a credit meter to which credit input via the credit input mechanism is added and a win meter;
a random number generator;
a game play mechanism including a plurality of buttons configured for operation by a player to input a wager from the established credits and to initiate a play of a game; and
a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with at least one wheel sector associated each of the different game play features, and at least one wheel sector associated with each one of a plurality of awards, and indicia for display in each respective wheel sector represent the sector association, and (v) one or more weight tables, and wherein the game controller is operable to assign prize values based on random outcomes as required during play of the game,
the game controller executing the game program code stored in the memory and responsive to initiation of the play of the game with the game play mechanism to:
configure the reels by replacing each instance of the dynamic scatter symbols of the reels with one of two or more of the feature associated scatter symbols;
select a plurality of symbols from the configured reels using the random number generator, and control the display to display the selected symbols in a plurality of columns of display positions to generate a reel spin outcome;
make an award of credits to the win meter or the credit meter based on any prize values assigned to combinations of symbols in the reel spin outcome;
review the reel spin outcome to determine any occurrence of a feature associated scatter symbol, wherein:
for each game play feature associated scatter symbol occurrence, assess a trigger condition for the game play feature based on a weight table and a random number generator output, and where the trigger condition being met provides an indication that the game feature is to be awarded;
for an occurrence of the wheel feature associated scatter symbol, trigger a wheel spin to select a wheel sector based on an output of the random number generator, wherein
selecting a sector associated with a prize award causes an award of credits to the win meter or the credit meter based on the prize;
selecting a sector associated with one of the features causes assessment of a trigger condition for the game play feature based on a weight table and a random number generator output, and where the trigger condition is met provide an indication that the game feature is to be awarded and modifying the selected sector to become associated with a start feature trigger; and
selecting a sector associated with a start feature trigger will cause start of a feature game wherein the game features to be awarded triggered from the spinning reel and wheel are provided in the feature game,
and wherein wheel spins are repeated until selection of the start trigger sector.

2. A gaming machine as claimed in claim 1, wherein the game play feature associated scatter symbols include:
a reel growth scatter symbol associated with a reel growth feature, wherein an extra row is added to a reel window for each occurrence of the reel growth scatter symbol in a feature game outcome; and/or
a free game scatter symbol, wherein for each occurrence of the free game scatter symbol at least one additional feature game round is awarded;
an upgrade scatter symbol, wherein for each occurrence of the upgrade scatter symbol at least one prize scatter symbol associated with a potential reel state upgrade replaces the upgrade scatter symbol on the reel.

3. A gaming system as claimed in claim 2, wherein the plurality of awards associated with wheel sectors include:
one or more bonus prizes;
one or more free games;
one or more coin accumulation increments.

4. A gaming machine as claimed in claim 3, wherein each reel has an associated coin accumulation indicator having a plurality of states, each state being associated with an increase in coin value and wherein state transition is based on a coin accumulation count.

5. A gaming machine as claimed in claim 4, wherein the coin accumulation indicator has three states.

6. A gaming machine as claimed in claim 4, wherein feature game play includes spinning reels and a spinning wheel, the spinning wheel having a plurality of sectors, each sector respectively associated with any one of an award, multiplier or boost feature, and when feature game play is triggered the game controller executes game program code to determine a number of rounds of feature game play and a weight table for the feature game play, and for each round:
configure the feature game reels to include at least one game play feature associated scatter symbol for each of the game play features to be awarded, at least one wheel feature associated scatter symbol, and at least one coin accumulation scatter symbol;
select a plurality of symbols from the configured feature game reels using the random number generator, and control the display to display the selected symbols in a plurality of columns of display positions to generate a feature game reel spin outcome;
review the reel spin outcome to determine any occurrence of a feature associated scatter symbol, wherein:
for each game play feature associated scatter symbol occurrence, execute the game play feature function based on a weight table and a random number generator output;
for each coin accumulation scatter symbol determine an award value for the occurrence based on a coin accumulation state of the of the reel; and
for each occurrence of a wheel spin scatter symbol, a wheel spin is executed to select a sector based on a random number generator output, and applying the award, multiplier or boost feature associated with the sector, and
wherein reel spins repeated until the number of feature spins have been executed.

7. A gaming machine as claimed in claim 6, wherein the boost feature causes an increase in credit value ranges associated with each coin state.

8. A gaming machine as claimed in claim 6, wherein awards associated with spinning reel sectors include a plurality of bonus awards.

9. A gaming machine as claimed in claim 7, wherein the trigger outcome of an assessment of a feature trigger will be one of a) trigger condition not met, b) trigger condition met, and c) trigger condition met and an extreme state applied for the feature game, wherein in the extreme state, operation of game features is based on an extreme state weight table and random number generator output, whereby volatility of feature awards is varied in the extreme state.

10. A gaming machine as claimed in claim 9, wherein the extreme state is only applicable if all game play features are to be awarded in the feature game rounds.

11. A method of operating a gaming machine comprising:
a display;
a credit input mechanism operable to establish credits on the gaming machine, the credit input mechanism including at least one of a coin input chute, a bill collector, a card reader and a ticket reader;
meters configured for monitoring credits established via the credit input mechanism and changes to the established credits due to play of the gaming machine, the meters including a credit meter to which credit input via the credit input mechanism is added and a win meter;
a random number generator;
a game play mechanism including a plurality of buttons configured for operation by a player to input a wager from the established credits and to initiate a play of a game; and
a game controller comprising a processor and memory storing (i) game program code, (ii) symbol data defining reels including dynamic scatter symbols, (iii) further symbol data defining a set of feature associated scatter symbols including one wheel feature associated scatter symbol and two or more game play feature associated scatter symbols each associated with a different game play feature, (iv) wheel data defining a plurality of wheel sectors, with one wheel sector associated with a start feature trigger, and each other sector associated with one of the different game play features or one of a plurality of awards, and indicia for display in each respective wheel sector represent the sector association, and (v) one or more weight tables, and wherein the game controller is operable to assign prize values based on random outcomes as required during play of the game,
the game controller executing the game program code stored in the memory and responsive to initiation of the play of the game with the game play mechanism, the method comprising the steps of:
configuring the reels by replacing each instance of the dynamic scatter symbols of the reels with one of two or more of the feature associated scatter symbols;
selecting a plurality of symbols from the configured reels using the random number generator, and control the display to display the selected symbols in a plurality of columns of display positions to generate a reel spin outcome;
making an award of credits to the win meter or the credit meter based on any prize values assigned to combinations of symbols in the reel spin outcome;
reviewing the reel spin outcome to determine any occurrence of a feature associated scatter symbol, wherein:
for each game play feature associated scatter symbol occurrence, assess a trigger condition for the game play feature based on a weight table and a random number generator output, and where the trigger condition is met provide an indication that the game feature is to be awarded;
for an occurrence of the wheel feature associated scatter symbol trigger a wheel spin to select a wheel sector based on an output of the random number generator, wherein
selecting a sector associated with a prize award causes an award of credits to the win meter or the credit meter based on the prize;
selecting a sector associated with one of the features causes assessment of a trigger condition for the game play feature based on a weight table and a random number generator output, and where the trigger condition is met provide an indication that the game feature is to be awarded; and
selecting a sector associated with a start feature trigger will cause start of a feature game wherein the game features to be awarded triggered from the spinning reel and wheel are provided in the feature game.

12. A method as claimed in claim 11, wherein the game play feature associated scatter symbols include:
a reel growth scatter symbol associated with a reel growth feature, wherein an extra row is added to a reel window for each occurrence of the reel growth scatter symbol in a feature game outcome;
a free game scatter symbol, wherein for each occurrence of the free game scatter symbol at least one additional feature game round is awarded;
an upgrade scatter symbol, wherein for each occurrence of the upgrade scatter symbol at least one prize scatter symbol associated with a potential reel state upgrade replaces the upgrade scatter symbol on the reel of the upgrade scatter symbol occurrence.

13. A method as claimed in claim 12, wherein the plurality of awards associated with wheel sectors include any one or more of:
one or more bonus prizes;
one or more free games; and
one or more coin accumulation increments.

14. A method as claimed in claim 13, wherein each reel has an associated coin accumulation indicator having a plurality of states, each state being associated with an increase in coin value and wherein state transition is based on a coin accumulation count.

15. A method as claimed in claim 14, wherein the coin accumulation indicator has three states.

16. A method as claimed in claim 14, wherein feature game play includes spinning reels and a spinning wheel, the spinning wheel having a plurality of sectors, each sector respectively associated with any one of an award, multiplier or boost feature, and
when feature game play is triggered the game controller executes game program code to determine a number of rounds of feature game play and a weight table for the feature game play, and for each round the method further comprises:
configuring the feature game reels to include at least one game play feature associated scatter symbol for each of the game play features to be awarded, at least one wheel feature associated scatter symbol, and at least one coin accumulation scatter symbol;
selecting a plurality of symbols from the configured feature game reels using the random number generator, and control the display to display the selected symbols in a plurality of columns of display positions to generate a feature game reel spin outcome;
reviewing the reel spin outcome to determine any occurrence of a feature associated scatter symbol, wherein:
for each game play feature associated scatter symbol occurrence, executing the game play feature function based on a weight table and a random number generator output;
for each coin accumulation scatter symbol determining an award value for the occurrence based on a coin accumulation state of the of the reel; and
for each occurrence of a wheel spin scatter symbol, executing a wheel spin to select a sector based on a random number generator output, and applying the award, multiplier or boost feature associated with the sector, and
wherein reel spins repeated until the number of feature spins have been executed.

17. A method as claimed in claim 16, wherein the boost feature causes an increase in credit value ranges associated with each coin state.

18. A method as claimed in claim 16, wherein awards associated with spinning reel sectors include a plurality of bonus awards.

19. A method as claimed in claim 17, wherein the trigger outcome of an assessment of a feature trigger will be one of a) trigger condition not met, b) trigger condition met, and c) trigger condition met and an extreme state applied for the feature game, wherein in the extreme state, operation of game features is based on an extreme state weight table and random number generator output, whereby volatility of feature awards is varied in the extreme state.

20. A method as claimed in claim 19, wherein the extreme state is only applicable if all the plurality of game play features are to be awarded in the feature game rounds.
